(19) United States
(12) Patent Application Publication
(10) Pub. No.: US 2025/0173606 A1
(43) Pub. Date: May 29, 2025

(54) AUTOMATED MACHINE-LEARNED LANGUAGE MODEL PROMPT RECOMMENDATIONS

(71) Applicant: Maplebear Inc., San Francisco, CA (US)

(72) Inventors: Ryan Dearing, Boise, ID (US); Jacob Jensen, Metuchen, NJ (US); Michael Parrott, Toronto (CA)

(21) Appl. No.: 18/523,612

(22) Filed: Nov. 29, 2023

(51) Int. Cl. G06N 20/00; G06F 40/205; G06F 40/279

(52) U.S. Cl. CPC G06N 20/00; G06F 40/205; G06F 40/279

(57) ABSTRACT

An online system may receive a registration of an application for a language model gateway configured as an intermediary between users and a first machine-learned language model. The online system may monitor a conversation associated with the application using the language model gateway. The conversation is between a user of the application and the first machine-learned language model and includes a prompt from the user directed toward the first machine-learned language model. The online system may extract the prompt and compile an input for a second machine-learned language model that is fine-tuned to improve prompts. The input may be the prompt and one or more criteria to improve the prompt. The online system may provide the input to the second machine-learned language model. The online system may determine a suggested improvement to the prompt using the second machine-learned language model and provide the suggested improvement to the user.

### BACKGROUND

In the realm of artificial intelligence, machine learning models have evolved into complex and expansive entities. Particularly the language models in natural language processing have become increasingly sophisticated. The models often incorporate an enormous number of parameters to facilitate natural language understanding and generation. These models are instrumental in understanding and generating human language, offering tremendous potential across various applications. While the potential for these language models is immense, understanding how to properly use the models to elicit the most relevant and direct responses from these models has proven to be a challenging task.

### SUMMARY

A machine-learned language model is often a large and complex artificial intelligence model that could include billions of parameters. Because of the complexity of the language model, it is often a non-trivial and sometimes difficult task to determine what the best practice is to create a prompt to provide instructions or questions to a language model so that the language model provides a response that is most relevant and direct to the prompt. In one or more embodiments, an online system may include a gateway that intercepts and evaluates prompts, using various information from an online system and feedback from the users to determine whether the prompts are optimized for the desired outcome. A second machine-learned language model may be trained to generate recommendations of suggested improvements to the prompts. These recommendations may be based on recommendations across various prompts, but also tailored to the specific needs of an application. The online system may also utilize a feedback cycle to use suggested changes as implemented in an application to help determine whether the suggested improvements are better or worse.

By way of example, in one or more embodiments, an online system may receive a registration of an application for a language model gateway that is configured as an intermediary between users and a first machine-learned language model. The online system may monitor a conversation associated with the application using the language model gateway. The conversation is between a user of the application and the first machine-learned language model and includes a prompt from the user directed toward the first machine-learned language model. The online system may extract the prompt and compile an input for a second machine-learned language model that is fine-tuned to improve prompts. The input may be the prompt and one or more criteria to improve the prompt. The online system may provide the input to the second machine-learned language model. The online system may determine a suggested improvement to the prompt using the second machine-learned language model and provide the suggested improvement to the user.

### BRIEF DESCRIPTION OF THE DRAWINGS

FIG. 1A illustrates an example system environment for an online concierge system, in accordance with one or more embodiments.

FIG. 1B illustrates an example system environment for an online concierge system, in accordance with one or more embodiments.

FIG. 2 illustrates an example system architecture for an online concierge system, in accordance with one or more embodiments.

FIG. 3 is a block diagram illustrating an example architecture for improving prompts in communication with a machine-learned language model, in accordance with one or more embodiments.

FIG. 4 is a flowchart depicting an example process of improving a prompt in a conversation between a user and a language model, in accordance with some embodiments.

FIG. 5 is a flowchart depicting an example processor of systematically evaluating a prompt, in accordance with one or more embodiments.

### DETAILED DESCRIPTION

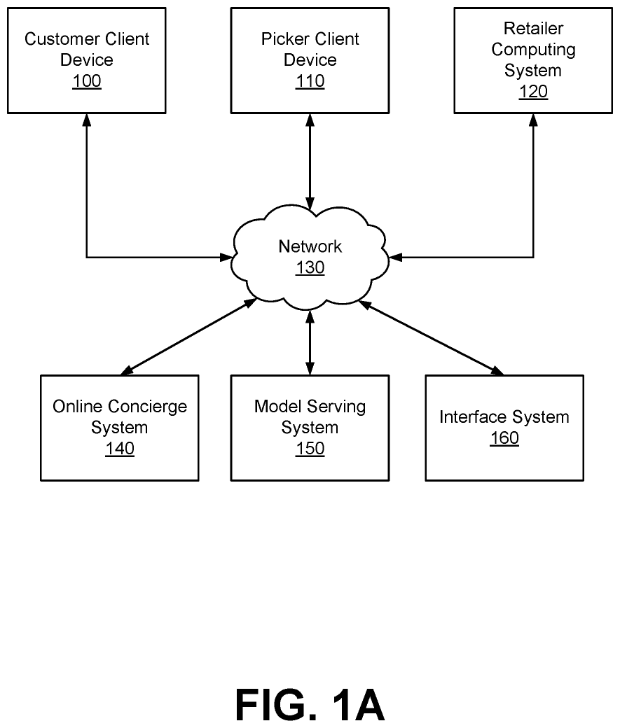

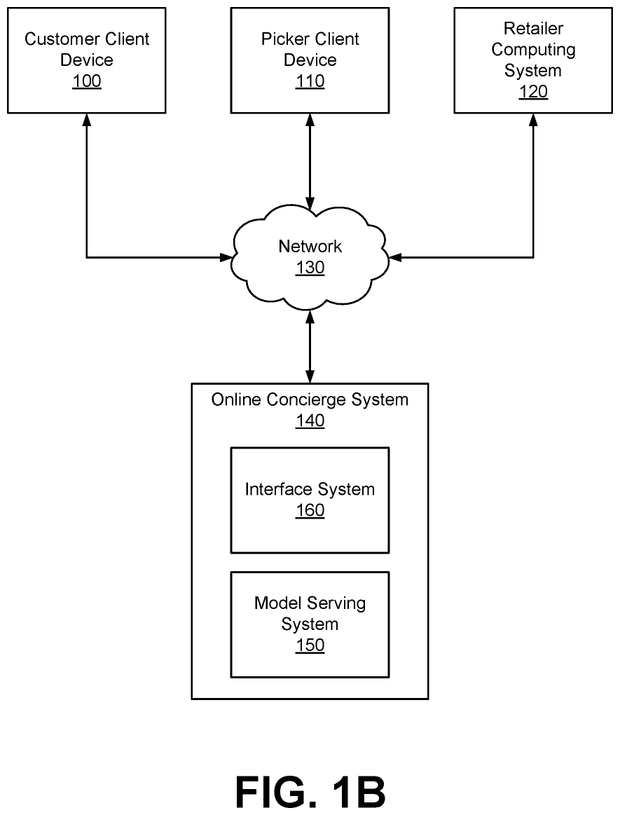

FIG. 1A illustrates an example system environment for an online concierge system 140, in accordance with one or more embodiments. The system environment illustrated in FIG. 1A includes a customer client device 100, a picker client device 110, a retailer computing system 120, a network 130, and an online concierge system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or a desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real-time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines the weights for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order.

Alternatively, more than one person may serve the role of a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi-or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

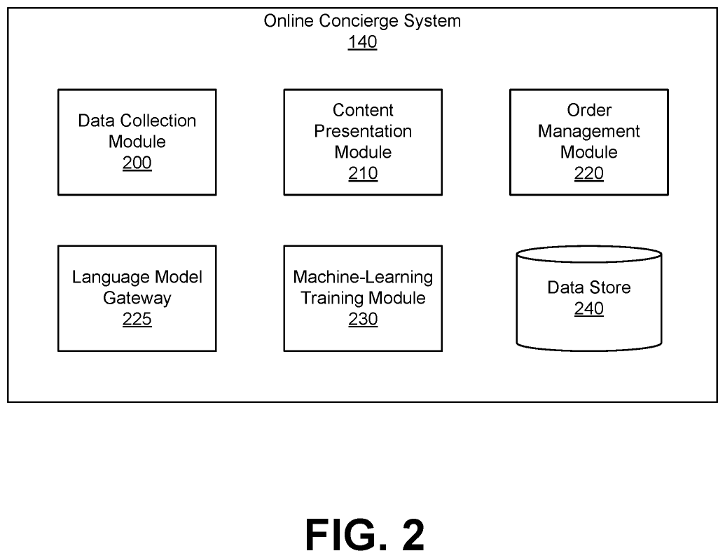

As an example, the online concierge system 140 may allow a customer to order groceries from a grocery store retailer. The customer's order may specify which groceries they want to be delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

The model serving system 150 receives requests from the online concierge system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens is arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has a significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online concierge system 140 or one or more entities different from the online concierge system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more other embodiments, the transformer architecture may have an encoder-decoder architecture and includes a set of encoders coupled to a set of decoders. An encoder or decoder may include one or more attention operations.

While an LLM with a transformer-based architecture is described in In one or more embodiments, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online concierge system 140 performs prompt engineering and improvement to prompts to a first machine-learned language model using a second machine-learned language model. Specifically, the online concierge system 140 prepares a prompt for input to the model serving system 150. The online concierge system 140 receives a response to the prompt from the model serving system 150 based on the execution of the machine-learned model using the prompt. The online system 140 monitors the conversations including the prompts and the responses and generates training samples based on the prompts to fine-tune the second machine-learned language model to provide suggested improvements of prompts that can be used in the first machine-learned language model.

In one or more embodiments, the task for the model serving system 150 is based on knowledge of the online concierge system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online concierge system 140 is connected to an interface system 160. The interface system 160 receives external data from the online concierge system 140 and builds a structured index over the external data using, for example, another machine-learned language model or heuristics. The interface system 160 receives one or more queries from the online concierge system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online concierge system 140 can generate a prompt using the external data as context, oftentimes, the amount of information in the external data exceeds prompt size limitations configured by the machine-learned language model. The interface system 160 can resolve prompt size limitations by generating a structured index of the data and offers data connectors to external data sources.

In one or more embodiments, the online concierge system 140 performs prompt improvement based on data and metrics maintained by the online concierge system 140. Specifically, the online concierge system 140 provides metrics and data to the interface system 160. The online concierge system 140 provides a query to the interface system 160. The online concierge system 140 receives a response to the prompt from the interface system 160 based on the execution of the machine-learned model in the model serving system 150 using prompts generated by the interface system 160. The interface system 160 may be used to provide data that can be used to train a language model. For example, a language model may be configured to generate suggested improvements to prompts that are intended to improve one or more metrics as measured by historical data of the online concierge system 140.

FIG. 1B illustrates an example system environment for an online concierge system 140, in accordance with one or more embodiments. The system environment illustrated in FIG. 1B includes a customer client device 100, a picker client device 110, a retailer computing system 120, a network 130, and an online concierge system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online concierge system 140. In one or more embodiments, as illustrated in the example system environment in FIG. 1B, the model serving system 150 and/or the interface system 160 is managed and deployed by the entity managing the online concierge system 140.

FIG. 2 illustrates an example system architecture for an online concierge system 140, in accordance with some embodiments. The system architecture illustrated in FIG. 2 includes a data collection module 200, a content presentation module 210, an order management module 220, a language model gateway 225, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describes the characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has service orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine the likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on the relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict the likelihood that an item is available at a retailer location or may predict an estimated number of items that are available at a retailer location. The content presentation module 210 may weigh the score for an item based on the predicted availability of the item. Alternatively, the content presentation module 210 may filter out items from presentation to a customer based on whether the predicted availability of the item exceeds a threshold.

The order management module 220 manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes the total cost for the order and charges the customer that cost. The order management module 220 may provide a portion of the total cost to the picker for servicing the order, and another portion of the total cost to the retailer.

A language model gateway 225 may take the form of a server, a software component, or any combination that may serve as an intermediary between any component of the online concierge system 140 and the model serving system 150. The language model gateway 225 is used to facilitate data communication and exchange, routing messages between a module of the online concierge system 140 and a language model so that the online system 310 can analyze the messages for training and improvements of various modules and language models used by the 310.

The machine learning training module 230 trains machine learning models used by the online concierge system 140. For example, the machine learning module 230 may train the item selection model, the availability model, or any of the machine-learned models deployed by the model serving system 150. The online concierge system 140 may use machine learning models to perform the functionalities described herein. Example machine learning models include regression models, support vector machines, naïve Bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied to each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label that represents an expected output of the machine learning model. In these cases, the machine learning model is trained by comparing its output from the input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online concierge system 140. In one or more other embodiments, when the model serving system 150 is included in the online concierge system 140, the machine-learning training module 230 may further train parameters of the machine-learned model based on data specific to the online concierge system 140 stored in the data store 240. As an example, the machine-learning training module 230 may obtain a pre-trained transformer language model and further fine-tune the parameters of the transformer model using training data stored in the data store 240. The machine-learning training module 230 may provide the model to the model serving system 150 for deployment.

### Example Prompt Improvement Architecture

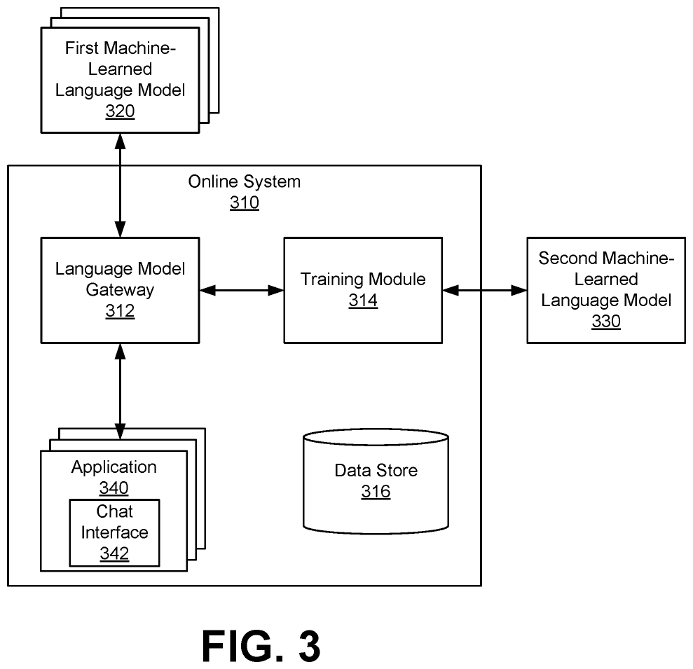

FIG. 3 is a block diagram illustrating an example architecture for improving prompts in communication with a machine-learned language model, in accordance with one or more embodiments. The architecture may include an online system 310, a first machine-learned language model 320, and a second machine-learned language model 330. There can be one or more instances of each component illustrated in FIG. 3. For example, there can be multiple instances of the first machine-learned language model 320 with some of them fine-tuned to one or more specific applications. One or more components may also be removed in some embodiments.

The online system 310 is an online system that provides one or more applications 340 to users. Some of the applications 340 use a first machine-learned language model 320 to generate content and results for users. An online concierge system 140 is an example of the online system 310. The one or more applications 340 provided by the online system 310 include various features and services for users, depending on the nature of the online system 310. In the context of the online concierge system 140, the applications may be any of the features and modules that are discussed in FIG. 2. For example, one application 340 may be an application that discusses with a user in natural language for creating and recommending a recipe based on the user's input, his or her profiles, and historical data including purchases, views, and other activities. Another application 340 may be an item recommendation discussion with a user as the user is selecting items in an order through the online concierge system 140. Yet another application 340 may be a conversational guidance application for helping a picker to find an item at a retailer location. Many other applications are also possible.

While the online concierge system 140 and its corresponding applications are used as the primary example for improving prompts in communication with a machine-learned language model, the online system 310 can be of any nature in various embodiments. The prompt improvement techniques and architecture are limited specifically to the features and applications provided by the online concierge system 140.

In the illustration shown in FIG. 3, the online system 310 may include one or more one or more applications 340, a language model gateway 312, a training module 314, and a data store 316. In various embodiments, the online system 310 may include additional, fewer, or different components. For example, as shown in FIG. 3, the first machine-learned language model 320 and the second machine-learned language model 330 are illustrated as being outside of the online system 310. In this arrangement, the first machine-learned language model 320 and the second machine-learned language model 330 may be stored and provided by the model serving system 150 in FIG. 1. The first machine-learned language model 320 and second machine-learned language model 330 may be trained or retrained (fine-tuned) by the mechanism of the interface system 160 as discussed in association with FIG. 1. In other embodiments, the online system 310 trains its own machine-learned language models and the first machine-learned language model 320 and/or the second machine-learned language model 330 may be part of the internal models used by the online system 310. Other arrangements are also possible in various embodiments.

Applications 340 include applications that use one or more machine-learned language models to provide services and functionalities to users. An application 340 may include a chat interface 342 that allows a user to carry out a conversation with the first machine-learned language model 320. The conversation includes one or more prompts (e.g., questions) provided by the user and responses generated by the first machine-learned language model 320 and forwarded to the user as displayed in the chat interface 342. A user may ask the first machine-learned language model 320 to perform a particular task, such as to create a new recipe. The first machine-learned language model 320 provides a response based on the specification of the application 340. For example, in some embodiments, a particular instance of the first machine-learned language model 320 is fine-tuned to the context of application 340, such as being fine-tuned to generate a recipe. In some embodiments, the first machine-learned language model 320 may weigh certain types of data more heavily, such as the user's past purchases, in generating the result. The application 340 may specify one or more types of data that are relevant to generating the responses by the first machine-learned language model 320.

In some embodiments, an application 340 is associated with one or more objectives that may also be referred to as goals. The objectives may be defined by the engineers who design the application 340. An objective can be of any nature, whether it is a binary or multi-label, metric-based or not, objective. For example, in some applications 340, an objective can be measured simply as whether the user is satisfied with a result generated by the application 340. An application 340 may include a binary feedback button (thumb up/thumb down) or a rating button that allows the user to provide feedback on the result of the application 340. In some applications 340, an objective can be defined through one or more metrics that are monitored by the online system 310 (e.g., the online concierge system 140). For example, in a recipe creation application, in addition to the user's feedback on whether the user is satisfied with the recipe, an alternative or additional objective can be whether the recipe recommendation of the application 340 results in the user including an item of the recipe in a purchase. Other metrics that may be used in an online system 310 (e.g., the online concierge system 140) for measuring objectives of an application 340 include click-through rate, bookmarked rate, conversion rate, bounce rate, time of application, scroll depth, share count, session duration, interaction rate of the application, engagement rate of the application, churn rate of the application, purchase rate, number of items added to cart, order value, repeat purchase rate, product return rate, checkout abandonment rate, and any of the combination or aggregation of one or more those metrics. Other metadata and performance metrics about the interaction with the online system 310, the application 340, or the first machine-learned language model 320 are also possible.

A language model gateway 312 may take the form of a server, a software component, or any combination that serves as an intermediary between an application 340 (e.g., the chat interface 342) and a first machine-learned language model 320. The language model gateway 312 is used to facilitate data communication and exchange, routing between multiple applications 340 and multiple first machine-learned language models 320, intercepting the conversations between a user and a first machine-learned language model 320 so that the online system 310 can recommend improvements to the prompts provided by the user. The language model gateway 312 may be an example of language model gateway 225. In some embodiments, one or more first machine-learned language models 320 are fine-tuned differently based on the underlying natures and objectives of the corresponding applications 340. The language model gateway 312 receives input from a user, identifies the correct first machine-learned language model 320, and routes the input to the first machine-learned language model 320. When the first machine-learned language model 320 provides a response, the language model gateway 312 routes the response back to the right application 340, which displays the response to the user. Through routing the messages in the conversation, the language model gateway 312 may save a copy of the conversation and provide the copy to the training module 314 and second machine-learned language model 330 for further analysis in improving the prompts that are used by the user.

In some embodiments, the communications between the language model gateway 312 and the server (e.g., model serving system 150) hosting one or more first machine-learned language models 320 are conducted through an application programming interface (API). In some embodiments, one or more first machine-learned language models 320 are fine-tuned for an application 340 based on the data of the first machine-learned language model 320 and the objectives of the corresponding application 340. The fine-tuning may be performed by the interface system 160 which is discussed in FIG. 1. The fine-tuned first machine-learned language model 320 is associated with an identifier. The language model gateway 312 uses a command line with an identifier to route messages in a conversation using an API.

While FIG. 3 is illustrated as the online system 310 having the language model gateway 312, in some embodiments an application 340 may directly communicate with a first machine-learned language model 320 and uses the second machine-learned language model 330 to improve the prompts used in the application 340 without the involvement of an intermediary.

In some embodiments, the online system 310 implements a registration process for any application 340 before application 340 uses the language model gateway 312 to communicate with a first machine-learned language model 320. In a registration process, the designer of the application 340 may provide the online system 310 with one or more stated goals of the application 340. If a specifically fine-tuned first machine-learned language model 320 should be used with the application 340, an identifier of the fine-tuned first machine-learned language model 320 may also be provided to the online system 310. After the registration, the language model gateway 312 starts routing conversations between users of the application 340 and the first machine-learned language model 320. The online system 310 may use one or more stated goals of the application 340 as criteria for the second machine-learned language model 330 to improve the prompts used by the users.

In some embodiments, the language model gateway 312 also monitors other aspects of an application 340 in addition to the conversation between a user and the first machine-learned language model 320. For example, an application 340 may include a feedback process that collects feedback from the user related to the results generated by the first machine-learned language model 320. The user may provide approval, disapproval, rating, and substantive comments on the application 340. The language model gateway 312 collects the information and uses the information to improve the prompts of the users using the application 340.

The prompts, the responses, and feedback provided by the users are saved as training samples for training the second machine-learned language model 330. For example, a conversation that resulted in approval (e.g., thumb up) feedback from a user can be saved as a positive training sample of an appropriate prompt that resulted in a positive user experience in a conversation. In another example, a conversation that resulted in a purchase by a user can also be saved as a positive training sample of an appropriate prompt. In yet another example, a conversation that resulted in the user and the first machine-learned language model 320 diverging the conversation from the main objective of the application 340 (e.g., user discussing weather with the language model in a recipe creation application) can be saved as a negative training sample of a prompt. Such prompts by the user can be improved through the second machine-learned language model 330.

A first machine-learned language model 320 is a language model that is used to provide responses to users of an application 340. Examples of various versions of a first machine-learned language model 320 are discussed as models provided by the model serving system 150 in FIG. 1. The online system 310 may communicate with more than one first machine-learned language model 320. Some first machine-learned language models 320 may be pre-trained by the model serving system 150 and no further alteration is performed by the online system 310. Other first machine-learned language models 320 may be fine-tuned (e.g., re-trained) using data specific to the online system 310 and/or data and objectives specific to an application 340. The term “first” is used to describe a number of machine-learned language models 320 that are used for generating responses to the users of the applications 340 and to distinguish a “second” machine-learned language model 330 that is used for generating best practice prompts. However, the collective reference of multiple language models as the first machine-learned language model 320 does not imply that each of the first machine-learned language models 320 has the same architecture, characteristics, or parameters that are in common with another first machine-learned language model 320. Each first machine-learned language model 320 in communication with the online system 310 can be a different language model.

A second machine-learned language model 330 is a language model that is fine-tuned to provide improvements to user prompts that are used in an application 340. A second machine-learned language model 330 may be referred to as a best-practice prompt language model or a prompt engineering language model. While in FIG. 3 the second machine-learned language model 330 is illustrated as having a single instance, in some embodiments, the online system 310 may have multiple applications 340 and each application 340 may have a dedicated and fine-tuned second machine-learned language model 330 for specifically improving the prompts used in the application 340. A second machine-learned language model 330 receives a prompt as part of the input and outputs a suggested improvement to the prompt. The second machine-learned language model 330 may also receive other data as inputs such as the stated goals of the application 340, data of the online system 310, and other relevant data and information.

In one or more embodiments, a training module 314 is an engine maintained by the online system 310 to fine-tune (e.g., training and re-training) the second machine-learned language model 330. In one or more embodiments, the training module 314 can be an example of the machine learning training module 230. The training module 314 may generate training samples for the second machine-learned language model 330 such as collecting conversations routed in the language model gateway 312 and packaging those conversations with additional data (e.g., feedback, metrics, other contextual data, and metadata) as training samples for fine-tuning the second machine-learned language model 330. The training samples may be generated as structured representations of prompts using one or more techniques such as PromptLab, GPT Index, and/or Langchain. The training module 314 may initially fine-tune the second machine-learned language model 330 and periodically re-train the second machine-learned language model 330 as training module 314 collects additional training samples through the usage of various applications 340.

In one or more embodiments, the training module 314 also systematically evaluates the suggested improvements outputted by the second machine-learned language model 330 to determine whether the suggested improvements truly improve the prompts such as by improving one or more objectives of an application 340. For example, the training module 314 uses a metric to define the performance (e.g., click rate, purchase rate, etc.) of the application 340. The training module 314 may conduct a systematic evaluation of various versions of prompts by monitoring the change in the metric through different testing methods, such as an A/B testing. In one or more embodiments, the training module 314 measures a first metric value corresponding to using the user's prompt in an application 340. The training module 314 receives from the second machine-learned language model 330 a suggested improvement of the prompt. The training module 314 causes the use of the suggested improvement (e.g., by recommending the suggested improvement to various other users) in the application 340 to generate results. The training module 314 measures a second metric value corresponding to the results of the suggested improvement. The training module 314 compares the first metric value to the second metric value to determine whether the suggested improvement improves the application.

In one or more embodiments, the training module 314 includes one or more heuristics to improve prompts related to contextual data retrieval. For example, the training module 314 includes a heuristic to define the relevant metrics in measuring a stated goal of an application 340. In one or more embodiments, the training module 314 includes a heuristic to define what contextual data is relevant to a particular application 340. In one or more embodiments, the training module 314 includes a heuristic to perform testing on whether the suggested improvement provided by second machine-learned language model 330 improves the performance of the application 340.

In one or more embodiments, a data store 316 is a data store that stores various types of data of the online system 310. The data store 316 is an example of the data store 240. Both the first machine-learned language model 320 and the second machine-learned language model 330 may use the data store 240 to generate outputs. For example, the data of the data store 316 may be indexed for retrieval by a first machine-learned language model 320. Some first machine-learned language models 320 may use the data of the online system 310 to deliver responses that are specific to the context of the online system 310. A second machine-learned language model 330 may also be trained using the data in the data store 316 and may improve prompts based on the data in the data store data store 316. For example, the second machine-learned language model 330 may generate a suggested improvement to a prompt based on a criterion defined by a metric that is used to monitor the performance of an application 340.

### Example Prompt Improvement Process

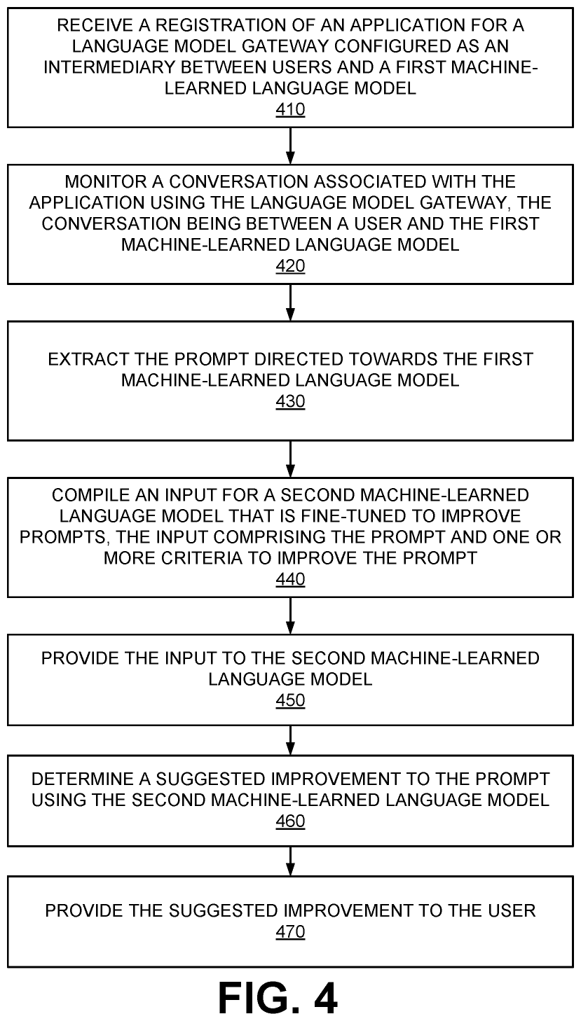

FIG. 4 is a flowchart depicting an example process of improving a prompt in a conversation between a user and a language model, in accordance with some embodiments. Alternative embodiments may include more, fewer, or different steps from those illustrated in FIG. 4, and the steps may be performed in a different order from those illustrated in FIG. 4. These steps may be performed by an online system 310 (e.g., online concierge system 140). Additionally, each of these steps may be performed automatically by the online concierge system without human intervention.

The online system 310 receives 410 a registration of an application 340 for a language model gateway 312 configured as an intermediary between users and a first machine-learned language model 320. In some embodiments, the language model gateway 312 may serve as an intermediary for multiple related applications 340 that serve different purposes. The registration process may include the designer of application 340 providing one or more stated goals of the application 340. A stated goal may be used as one criterion to generate a suggested improvement of a prompt used in application 340. The online system 310 also connects a chat interface 342 of the application 340 with the language model gateway 312. After the registration, the language model gateway 312 starts routing conversations between users of the application 340 and the first machine-learned language model 320. In some embodiments, an intermediary is not used between an application 340 and a first machine-learned language model 320 and the step 410 may be skipped.

The online system 310 monitors 420 a conversation associated with the application 340 using the language model gateway 312. The conversation is between a user and the first machine-learned language model 320. The conversation includes a prompt from the user directed toward the first machine-learned language model 320 and a response from the first machine-learned language model 320. For example, a user may ask the first machine-learned language model 320 to create a recipe by typing a question, “Can you create a recipe for chocolate cake with no gluten?” or “Can you provide a recipe for a well-rounded dinner with no meat?” The first machine-learned language model 320 may provide an answer that is in the form of a recipe and cooking instruction. The user may follow up with additional questions or instructions to adjust the recipe. Each of the questions or instructions, including the initial question, may be considered as a prompt that can be improved by the second machine-learned language model 330.

In monitoring the conversation, the online system 310 routes the prompt from the user to the first machine-learned language model 320. The online system 310 also routes the response from the first machine-learned language model 320. The online system 310 may receive feedback from the user regarding a rating of the conversation with the first machine-learned language model 320. The online system 310 stores the prompt, the response and the feedback as a training sample for training of the second machine-learned language model 330. The training sample can be packaged in a structured manner. Structured representations of prompts as well as final evaluations and metrics can be used for training samples in fine-tuning the second machine-learned language model 330.

The online system 310 extracts 430 the prompt directed toward the first machine-learned language model. The language model gateway 312 receives a prompt from the application 340, such as the initial question or a follow-up instruction. The language model gateway 312 forwards the prompt to the first machine-learned language model 320 such as by generating an API call to the first machine-learned language model 320. In addition, the language model gateway 312 may save a copy of the prompt and the entire conversation. The prompt extracted is further routed to the second machine-learned language model 330 to evaluate the prompt.

The online system 310 compiles 440 an input for a second machine-learned language model 330 that is fine-tuned to improve prompts. The online system 310 also provides 450 the input to the second machine-learned language model.

The input may include the prompt and may additionally one or more criteria to improve the prompt, depending on how the second machine-learned language model 330 is fine-tuned. For example, in one or more embodiments, the second machine-learned language model 330 is fine-tuned to immediately recognize the input is a prompt without further explanation. Such a second machine-learned language model 330 may also have been fine-tuned based on one or more criteria specific to an application 340. In such a case, the input may directly be the prompt itself and the second machine-learned language model 330 automatically understands that the model needs to improve the input. In some embodiments, the input compiled may include the prompt and also the objectives of the application 340 or the prompt so that the second machine-learned language model 330 is instructed to improve the prompts based on the objectives. In some embodiments, the input compiled may further include the entire conversation between the user and the first machine-learned language model 320. In various embodiments, the input to the second machine-learned language model 330 may include one or more stated goals of the application 340, the conversation between the user and the first machine-learned language model 320, feedback or comments by the user on the conversation, target metrics that are relevant to improving the prompt, a purpose of the prompt, and/or guardrail metrics.

In various embodiments, different ways can be used to compile the input to the second machine-learned language model 330. In one or more embodiments, the online system 310 compiles the input for the second machine-learned language model 330 in natural language. For example, the online system 310 adds the prompt and the one or more criteria to improve the prompt as one or more natural language phrases that serve as the input to the second machine-learned language model 330. A criterion can be as simple as to allow the user to receive a satisfactory answer. In some embodiments, a series of natural language sentences may be compiled as inputs to the second machine-learned language model 330. The online system 310 may first ask the second machine-learned language model 330 to identify the nature of the conversations and then sequentially direct the second machine-learned language model 330 in natural language to improve one or more prompts in the conversation. For example, the online system 310 may have a conversation with the second machine-learned language model 330 in the following fashion.

Question to the second machine-learned language model 330: What are these questions about? “Can you create a recipe for chocolate cake with no gluten?”, “Can you provide a recipe for a well-rounded dinner with no meat?”

Response from the second machine-learned language model 330: These questions are requests for recipes that cater to specific dietary preferences or restrictions. In both cases, the questions are specific to dietary requirements or preferences, indicating that the individuals are looking for recipes that align with their chosen lifestyles or health considerations.

Question to the second machine-learned language model 330: I′m using an application that will allow users to ask these types of questions to an LLM. What kind of context should I provide the LLM before sending it user requests to increase the chance of the user getting a satisfactory answer from the LLM?Response from the second machine-learned language model 330: To provide the LLM (Large Language Model) with appropriate context before sending user requests, you should include relevant information that helps the model understand the user's specific dietary requirements and preferences. Context is essential for the model to generate accurate and relevant responses. Here's how you can structure the context: Special Tokens: Use special tokens to mark the start and end of the context. For example, you can use [CONTEXT] to indicate the beginning of the context and [USER_INPUT] to mark the start of the user's question.

In one or more embodiments, the online system 310 retrieves one or more stated goals of the application from the registration of the application. The online system 310 identifies one or more metrics in measuring the stated goals. For example, the stated goal of an application 340 may be to promote interactions of the user using the application 340. The online system 310 may identify the click-through rate and the conversion rate as two metrics that are used to measure the performance of the application 340 with respect to the stated goal. The online system 310 generates a structured representation of the prompt. The structured representation may include the prompt and the one or more metrics arranged in a structured format. For example, the online system 310 may package the conversation with additional data (e.g., feedback, metrics, other contextual data, and metadata) as a structured input to the second machine-learned language model 330. The generation of a structured representation of a prompt may be performed using one or more techniques such as PromptLab, GPT Index, and/or Langchain.

In one or more embodiments, the online system 310 compiles an input using the entire conversation between the user and the first machine-learned language model 320. In determining whether a prompt is successful, the online system 310 may monitor the content of the conversation to determine whether the conversation achieves the goal of the application 340. For example, after the initial prompt is sent to the first machine-learned language model 320, the online system 310 may monitor additional prompts and responses in the conversation. In some cases, the online system 310 may determine that the conversation has deviated from a stated goal associated with the conversation. For example, if application 340 is related to recipe creation, the online system 310 may use another language model to determine whether the user stays on the topic of recipe and cooking in the conversation. In response to the online system 310 determining that the conversation has deviated from the stated goal of the conversation (e.g., the stated goal of the conversation can be the same as the stated goal of the application 340), the online system 310 compiles the conversation as the input to ask the second machine-learned language model 330 how to improve the prompt to make the conversation to be more likely to be in line with the stated goal associated with the conversation.

The online system 310 determines 460 a suggested improvement to the prompt using the second machine-learned language model 330. In some embodiments, the second machine-learned language model 330 outputs a suggested improvement that is intended to serve as the direct replacement of the prompt used by the user. For example, instead of the initial prompt “Can you create a recipe for chocolate cake with no gluten?”, the second machine-learned language model 330 may generate a suggested improvement “Can you create a recipe that includes only available items that I can add to cart for chocolate cake with no gluten?” The stated objective of the recipe creation application 340 in this example may be to promote purchase. In another example, the suggested improvement may be a new prompt or instruction that may be used to change or complement the original prompt. For example, the suggested improvement may be “tell the LLM agent to be a chef,” or “send ingredients to a function call, and instructions to another function call.”

In some embodiments, the second machine-learned language model 330 provides a “compiled prompt” that breaks a prompt into multiple prompts or changes the structure of the conversation. For example, instead of or in addition to suggesting a replacement to the prompt, the second machine-learned language model 330 may also generate an additional prompt that is recommended to be inserted before or above the prompt that is inputted to the second machine-learned language model 330. By way of example, the online system 310 breaks the conversation into one or more units. The online system 310 receives a suggested change in one of the units from the second machine-learned language model. The units in the conversation may be identifiable sections in the conversation, such as the initial prompt, a transition, a change in topic, etc. The second machine-learned language model 330 analyzes the semantics and contextual relationships of the messages in the conversation and determines the units of the conversation.

The online system 310 provides 470 the suggested improvement to the user. The suggested improvement may be provided to the user in various manners. For example, the online system 310 may cause the application 340 to display the suggested improvement to the user while the user is in a conversation. The suggested improvement may be immediately displayed as a tip for the user to change the original prompt to a better prompt. Alternatively, or additionally, the online system 310 may also automatically replace the original prompt with the suggested improvement. The online system 310 may dynamically create new prompts with automatic measurement towards a target metric (increased add to cart, increased conversion rate, etc.). The suggested improvement may be returned as part of the response from the language model gateway 312. The suggested improvement may also be delivered out-of-band via reports or other methods (e.g., email to the user, or a collective summary of various prompts and performance to the administrator of the application 340). Other delivery methods of the suggested improvement may include automated emails, an admin interface, and/or an API for polling suggestions. The suggested improvement may be provided to the designer of the application 340 to help the designer to optimize the prompts and applications.

### Evaluating Prompt Improvement

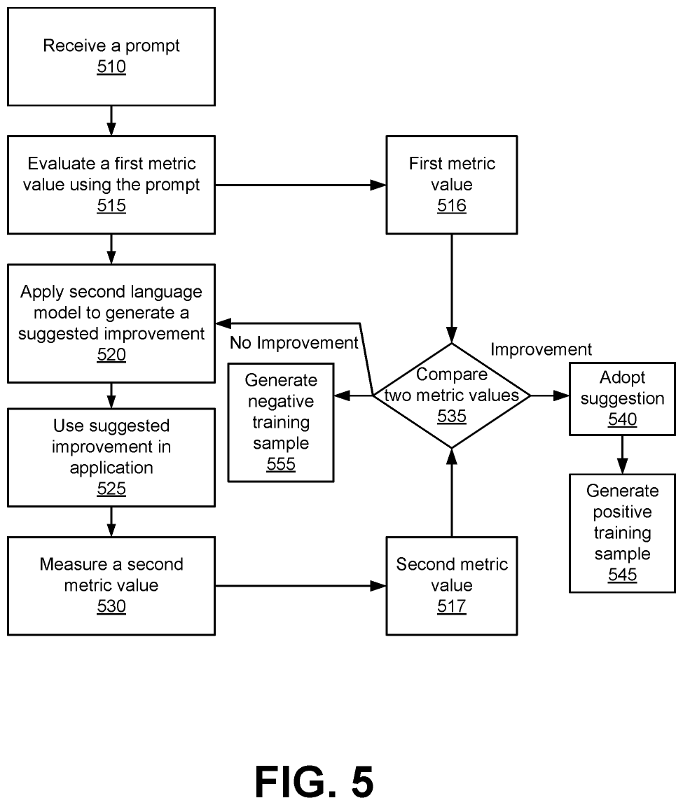

FIG. 5 is a flowchart depicting an example processor of systematically evaluating a prompt, in accordance with one or more embodiments. Alternative embodiments may include more, fewer, or different steps from those illustrated in FIG. 5, and the steps may be performed in a different order from those illustrated in FIG. 5. These steps may be performed by an online system 310 (e.g., online concierge system 140). Additionally, each of these steps may be performed automatically by the online concierge system without human intervention.

The online system 310 receives 510 a prompt from a user who engages in a conversation in an application 340 with a first machine-learned language model 320. The online system 310 evaluates 515 a first metric value 516 corresponding to using the prompt in the application 340. The online system 310 applies 520 the second machine-learned language model 330 to generate a suggested improvement to the prompt. The online system 310 uses 525 the suggested improvement in the application 340 to generate more results. The online system 310 measures 530 a second metric value 517 corresponding to the result of the suggested improvement. In decision stage 535, the online system 310 compares the first metric value 516 to the second metric value 517 to determine whether the suggested improvement improves the application 340. In response to the suggested improvement is determined to be improving the application 340, the online system 310 adopts 540 the suggested improvement as a recommendation to be provided to the user. The online system 310 may also generate 545 a positive training sample for fine-tuning the second machine-learned language model 330. In response to the suggested improvement is determined to be not improving application 340, the online system 310 may apply 520 the second machine-learned language model 330 to generate another suggested improvement. The online system 310 may also generate 555 a negative training sample for fine-tuning the second machine-learned language model 330.

### Model Training and Re-Training

In various embodiments, a wide variety of machine learning techniques may be used to train and re-training (e.g., fine-tuning) a machine-learned language model. Examples include different forms of supervised learning, unsupervised learning, and semi-supervised learning. Natural language may be converted into word embedding using one or more neural networks that are trained to create word embedding. The prompt training samples may be used to fine-tune a second machine-learned language model 330. For example, training and retraining of a second machine-learned language model 330 may include retrieving a plurality of training samples. A training sample includes a prior prompt and a label associated with the effectiveness of the prior prompt. The effectiveness may be defined by a metric or by a label such as a binary label (positive or negative). The online system 310 uses the training samples to generate outputs of the second machine-learned language model 330. The online system 310 compares the outputs with labels of the training samples in forward propagation. In backpropagation, the online system 310 adjusts one or more parameters of the second machine-learned language models based on the comparison.

The training techniques for the second machine-learned language model 330 may be supervised, semi-supervised, or unsupervised. In supervised learning, the machine learning models may be trained with a set of training samples that are labeled. For example, for the second machine-learned language model 330 to be fine-tuned to improve prompts, the training samples may be a set of text prompts and corresponding target improved prompts. The second machine-learned language model 330 is trained to learn how to generate a suggested improvement for a given prompt. The training samples a set of prompts and one or more metrics that are used to measure the performance of an application 340 or the conversations. The second machine-learned language model 330 is trained to learn how to generate a prompt improvement that will result in a higher metric score. The labels for each training sample may be binary (positive or negative samples) or multi-class (e.g., a metric value). In training the second machine-learned language model 330, the training labels may include a positive label that indicates a corresponding prompt resulted in a good performance of an application 340 and a negative label that indicates a corresponding prompt did not result in a good performance of the application 340.

By way of example, the training set may include multiple past records of prompts with known outcomes of the conversation (e.g., whether the user is satisfied with the conversation, or the performance of the application 340 as measured by one or more metrics). Each training sample in the training set may correspond to a past and the corresponding outcome may serve as the label for the sample. A training sample may be represented as a structured representation using a technique such as PromptLab. The structured presentation may include multiple dimensions and each dimension may include a particular type of data. In various embodiments, certain pre-processing techniques may be used to normalize the values in different dimensions.

A machine learning model may be associated with an objective function, which generates a training metric value that describes the objective goal of the training process. The training process may intend to reduce the error rate of the model in generating predictions. In such a case, the objective function may monitor the error rate of the machine learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels.

A language model may include certain layers, nodes, and layers. The various components in a language model may include encoders, decoders, multi-head attention, add & norm unit, feed-forward layers, linear layers, and activation functions such as softmax activation functions. Each component may include multiple parameters whose values are determined in training and further adjusted in re-training.

Training or re-training of a neural network may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations. The functions may also include an activation function that adjusts the weight of the output of the node. Nodes in different layers may be associated with different functions.

Training or re-training of a machine learning model may include an iterative process that includes iterations of making determinations, monitoring the performance of the machine learning model using the objective function, and backpropagation to adjust the weights (e.g., weights, kernel values, coefficients) in various nodes. The computing device, in forward propagation, may use the machine learning model to generate the predicted outcome. The computing device may compare the predicted outcome with the labels of the training sample. The computing device may adjust, in a backpropagation, the weights of the machine learning model based on the comparison. The computing device backpropagates one or more error terms obtained from one or more loss functions to update a set of parameters of the machine learning model. The backpropagation may be performed through the machine learning model and one or more of the error terms based on a difference between a label in the training sample and the generated predicted value by the machine learning model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, softmax, sigmoid functions, hyperbolic tangent functions (tanh), and rectified linear unit functions (ReLU). After input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine learning model has converged) or after a predetermined number of rounds for a particular set of training samples.

In various embodiments, the training samples described above may be refined and continue to re-train the model, which is the model's ability to perform the inference tasks. In some embodiments, this training and re-training process may repeat, which results in a computer system that continues to improve its functionality through the use-retraining cycle. For example, after the model is trained, multiple rounds of re-training may be performed. The process may include periodically retraining the machine learning model. The periodic retraining may include obtaining an additional set of training data, such as through other sources, by usage of users, and by using the trained machine learning model to generate additional samples. The additional set of training data and later retraining may be based on updated data describing updated parameters in training samples. The process may also include applying the additional set of training data to the machine learning model and adjusting the parameters of the machine learning model based on the application of the additional set of training data to the machine learning model. The additional set of training data may include any features and/or characteristics that are mentioned above.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or distributedly, comprise instructions that, when executed by one or more processors, cause the one or more processors to perform, individually or distributedly, the steps of the instructions stored on the one or more computer-readable media. Similarly, a processor comprises one or more processors or processing units that, individually or distributedly, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method comprising, at an online system comprising one or more processors and one or more computer-readable media:
receiving a registration of an application for a language model gateway configured as an intermediary between users and a first machine-learned language model;
monitoring a conversation associated with the application using the language model gateway, the conversation being between a user of the application and the first machine-learned language model, the conversation comprising a prompt from the user directed toward the first machine-learned language model and a response from the first machine-learned language model;
extracting the prompt directed toward the first machine-learned language model;
compiling an input for a second machine-learned language model that is fine-tuned to improve prompts, the input comprising the prompt and one or more criteria to improve the prompt;
providing the input to the second machine-learned language model;
generating a suggested improvement to the prompt using the second machine-learned language model; and
providing the suggested improvement to the user.

2. The method of claim 1, wherein receiving the registration of the application for the language model gateway comprises:
receiving a stated goal of the application;
including the stated goal as the one or more criteria to improve prompts of the application; and
connecting a chat interface of the application with the language model gateway.

3. The method of claim 1, wherein monitoring the conversation associated with the application comprises:
routing the prompt from the user to the first machine-learned language model;
routing the response from the first machine-learned language model to the user;
receiving feedback from the user regarding a rating of the conversation with the first machine-learned language model; and
storing the prompt, the response and the feedback as a training sample for training of the second machine-learned language model.

4. The method of claim 1, wherein compiling the input for the second machine-learned language model comprises:
retrieving a stated goal of the application from the registration of the application;
identifying one or more metrics in measuring the stated goal; and
generating a structured representation of the prompt, the structured representation comprises the prompt and the one or more metrics arranged in a structured format.

5. The method of claim 1, wherein compiling the input for the second machine-learned language model comprises:
adding the prompt and the one or more criteria as a natural language phrase that serves as the input to the second machine-learned language model.

6. The method of claim 1, wherein compiling the input for the second machine-learned language model comprises:
monitoring additional prompts and responses in the conversation;
identifying that the conversation has deviated from a stated goal associated with the conversation; and
compiling the conversation as the input to ask the second machine-learned language model how to improve the prompt to make the conversation more likely to be in line with the stated goal associated with the conversation.

7. The method of claim 1, further comprising evaluating an effectiveness of the suggested improvement to the prompt, wherein evaluating the effectiveness of the suggested improvement to the prompt comprises:
measuring a first metric value corresponding to using the prompt in the application;
using the suggested improvement in the application to generate one or more results;
measuring a second metric value corresponding to the one or more results of the suggested improvement; and
comparing the first metric value to the second metric value to determine whether the suggested improvement improves the application.

8. The method of claim 1, wherein providing the suggested improvement to the user comprises causing to display the suggested improvement to the user while the user is in the conversation.

9. The method of claim 1, wherein identifying the suggested improvement to the prompt comprises:
breaking the conversation into one or more units; and
receiving a suggested change in one of the units from the second machine-learned language model.

10. The method of claim 1, further comprising fine-tuning the second machine-learned language model, wherein fine-tuning the second machine-learned language model comprises:
retrieving a plurality of training samples, wherein a training sample comprises a prior prompt and a label associated with an effectiveness of the prior prompt;
using the training samples to generate outputs of the second machine-learned language model;
comparing the outputs with labels of the training samples; and
adjusting, in backpropagation, one or more parameters of the second machine-learned language model based on the comparison.

11. The method of claim 1, wherein providing the suggested improvement to the user comprises automatically replacing the prompt of the user with the suggested improvement.

12. A computer program product comprising one or more non-transitory computer-readable storage media configured to store code comprising instructions, wherein the instructions, when executed, cause one or more processors to:
receive a registration of an application for a language model gateway configured as an intermediary between users and a first machine-learned language model;
monitor a conversation associated with the application using the language model gateway, the conversation being between a user of the application and the first machine-learned language model, the conversation comprising a prompt from the user directed toward the first machine-learned language model and a response from the first machine-learned language model;
extract the prompt directed toward the first machine-learned language model;
compile an input for a second machine-learned language model that is fine-tuned to improve prompts, the input comprising the prompt and one or more criteria to improve the prompt;
provide the input to the second machine-learned language model;
generate a suggested improvement to the prompt using the second machine-learned language model; and
provide the suggested improvement to the user.

13. The computer program product of claim 12, wherein the instruction to receive the registration of the application for the language model gateway comprises instructions to:
receive a stated goal of the application;
include the stated goal as the one or more criteria to improve prompts of the application; and
connect a chat interface of the application with the language model gateway.

14. The computer program product of claim 12, wherein the instruction to monitor the conversation associated with the application comprises instructions to:
route the prompt from the user to the first machine-learned language model;
route the response from the first machine-learned language model to the user;
receive feedback from the user regarding a rating of the conversation with the first machine-learned language model; and
store the prompt, the response and the feedback as a training sample for training of the second machine-learned language model.

15. The computer program product of claim 12, wherein the instruction to compile the input for the second machine-learned language model comprises instructions to:
retrieve a stated goal of the application from the registration of the application;
identify one or more metrics in measuring the stated goal; and
generate a structured representation of the prompt, the structured representation comprises the prompt and the one or more metrics arranged in a structured format.

16. The computer program product of claim 12, wherein the instruction to compile the input for the second machine-learned language model comprises instructions to:
add the prompt and the one or more criteria as a natural language phrase that serves as the input to the second machine-learned language model.

17. The computer program product of claim 12, wherein the instruction to compile the input for the second machine-learned language model comprises instructions to:
monitor additional prompts and responses in the conversation;
identify that the conversation has deviated from a stated goal associated with the conversation; and
compile the conversation as the input to ask the second machine-learned language model how to improve the prompt to make the conversation more likely to be in line with the stated goal associated with the conversation.

18. The computer program product of claim 12, wherein the instructions, when executed, further cause the one or more processors to evaluate an effectiveness of the suggested improvement to the prompt, wherein the instruction to evaluate the effectiveness of the suggested improvement to the prompt comprises instructions to:
measure a first metric value corresponding to using the prompt in the application;
use the suggested improvement in the application to generate one or more results;
measure a second metric value corresponding to the one or more results of the suggested improvement; and
compare the first metric value to the second metric value to determine whether the suggested improvement improves the application.

19. The computer program product of claim 12, wherein the instruction to provide the suggested improvement to the user comprises instructions to cause to display the suggested improvement to the user while the user is in the conversation.

20. A system comprising:
one or more processors; and
one or more non-transitory computer-readable storage media configured to store code comprising instructions, wherein the instructions, when executed, cause the one or more processors to:
receive a registration of an application for a language model gateway configured as an intermediary between users and a first machine-learned language model;
monitor a conversation associated with the application using the language model gateway, the conversation being between a user of the application and the first machine-learned language model, the conversation comprising a prompt from the user directed toward the first machine-learned language model and a response from the first machine-learned language model;
extract the prompt directed toward the first machine-learned language model;
compile an input for a second machine-learned language model that is fine-tuned to improve prompts, the input comprising the prompt and one or more criteria to improve the prompt;
provide the input to the second machine-learned language model;
generate a suggested improvement to the prompt using the second machine-learned language model; and
provide the suggested improvement to the user.
